(19) United States
(12) Patent Application Publication
(10) Pub. No.: US 2024/0012816 A1
(43) Pub. Date: Jan. 11, 2024

(54) SYSTEMS AND METHODS FOR AUTOMATING MULTIMODAL COMPUTATIONAL WORKFLOWS, AND NON-TRANSITORY STORAGE MEDIUM

(71) Applicant: Atgenomix Incorporated, Taipei City (TW)

(72) Inventors: Ming-Tai CHANG, Taipei City (TW); Wen-Chien WENG, Taipei City (TW); Yu-Ting LIN, Taipei City (TW)

(21) Appl. No.: 18/347,578

(22) Filed: Jul. 6, 2023

Related U.S. Application Data
(60) Provisional application No. 63/367,727, filed on Jul. 6, 2022.

(51) Int. Cl. G06F 16/2455; G06F 16/22

(52) U.S. Cl. CPC G06F 16/24553; G06F 16/221; G06F 16/24552

(57) ABSTRACT

A method for automating multimodal computational workflows enables an analysis process of an instruction set to be performed automatically in a cloud environment. Localizing step includes configuring a loader to load a dataset into dataframes of a memory or copy the dataset to a local host file system from a data source; configuring a transformer to transform the dataframes of the memory into a transformed dataset; configuring a formatter to format the transformed dataset to a formatted dataset; and configuring an executor to preprocess the formatted dataset as a managed table for a first command or save the formatted dataset to the local host file system for a second command. Delocalizing step includes configuring a collector to postprocess the command outputs outputted from the memory or retrieve the command outputs from the local host file system; and configuring a writer to save the command outputs to a storage.

### RELATED APPLICATIONS

This application claims priority to U.S. Provisional Application Ser. No. 63/367,727, filed Jul. 6, 2022, which is herein incorporated by reference.

### BACKGROUND

### Technical Field

The present disclosure relates to systems and methods for automating workflows, and a non-transitory storage medium. More particularly, the present disclosure relates to systems and methods for automating multimodal computational workflows, and a non-transitory storage medium.

### Description of Related Art

Whole genome sequencing, such as Next-generation sequencing (NGS), is progressively more applied to biomedical research, clinical, and personalized medicine applications to identify disease-associated and/or drug-associated genetic variants to advance precision medicine. The impact of NGS technologies in revolutionizing the biological and clinical sciences has been unprecedented.

Post-sequencing DNA analysis typically includes read mapping and variant calling, wherein annotation is optional. The analysis is very time-consuming computationally, especially for whole genome sequencing. With the ever increasing rate at which next-generation sequencing (NGS) data is generated, it is important to improve the data processing and analysis workflow.

As the complexity of an individual workflow increases to handle a variety of use cases or criteria, it becomes more challenging to optimally compute with it. For example, analyses may incorporate nested workflows, business logic, memoization, parallelization, the ability to restart failed workflows, or require parsing of metadata—all of which compound the challenges in optimizing workflow execution. Further, increases in complexity make it challenging to port computational workflows to different environments or systems. As a result of the increasing volume of biomedical data, analytical complexity, and the scale of collaborative initiatives focused on data analysis, reliable and reproducible analysis of biomedical data has become a significant concern. Accordingly, there is a need for improvements in computational workflow execution.

### SUMMARY

According to one aspect of the present disclosure, a method for automating multimodal computational workflows enables an analysis process of an instruction set to be performed automatically in a cloud environment. The method for automating multimodal computational workflows includes performing a localizing step, a processing step and a delocalizing step. The localizing step includes configuring a loader to load a dataset into dataframes of a memory or copy the dataset to a local host file system from a data source; configuring a transformer to transform the dataframes of the memory into a transformed dataset so as to optimize downstream data processing; configuring a formatter to format the transformed dataset to a formatted dataset; and configuring an executor to preprocess the formatted dataset as a managed table for a first command or save the formatted dataset to the local host file system for a second command. The processing step includes configuring a workflow engine executing on multiple processors to perform a task command of the instruction set on the dataset copied by the loader, the managed table or the formatted dataset to generate command outputs according to one of the first command and the second command. The delocalizing step includes configuring a collector to postprocess the command outputs outputted from the memory or retrieve the command outputs from the local host file system; and configuring a writer to save the command outputs to a storage. The first command is different from the second command.

According to another aspect of the present disclosure, a system for automating multimodal computational workflows enables an analysis process of an instruction set to be performed automatically in a cloud environment, and the system for automating multimodal computational workflows includes a memory and a plurality processors. The processors are signally connected to the memory. The memory and the processors are configured to perform a method for automating multimodal computational workflows, and the method for automating multimodal computational workflows includes performing a localizing step, a processing step and a delocalizing step. The localizing step includes configuring a loader to load a dataset into dataframes of the memory or copy the dataset to a local host file system from a data source; configuring a transformer to transform the dataframes of the memory into a transformed dataset so as to optimize downstream data processing; configuring a formatter to format the transformed dataset to a formatted dataset; and configuring an executor to preprocess the formatted dataset as a managed table for a first command or save the formatted dataset to the local host file system for a second command. The processing step includes configuring a workflow engine executing on the processors to perform a task command of the instruction set on the dataset copied by the loader, the managed table or the formatted dataset to generate command outputs according to one of the first command and the second command. The delocalizing step includes configuring a collector to postprocess the command outputs outputted from the memory or retrieve the command outputs from the local host file system; and configuring a writer to save the command outputs to a storage. The first command is different from the second command.

According to further another aspect of the present disclosure, a non-transitory storage medium has instructions therein, when executed, causing multiple processors to perform a method for automating multimodal computational workflows. The method for automating multimodal computational workflows includes performing a localizing step, a processing step and a delocalizing step. The localizing step includes configuring a loader to load a dataset into dataframes of a memory or copy the dataset to a local host file system from a data source; configuring a transformer to transform the dataframes of the memory into a transformed dataset so as to optimize downstream data processing; configuring a formatter to format the transformed dataset to a formatted dataset; and configuring an executor to preprocess the formatted dataset as a managed table for a first command or save the formatted dataset to the local host file system for a second command. The processing step includes configuring a workflow engine executing on the multiple processors to perform a task command of the instruction set on the dataset copied by the loader, the managed table or the formatted dataset to generate command outputs according to one of the first command and the second command. The delocalizing step includes configuring a collector to postprocess the command outputs outputted from the memory or retrieve the command outputs from the local host file system; and configuring a writer to save the command outputs to a storage. The first command is different from the second command.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a method for automating multimodal computational workflows according to a first embodiment of the present disclosure.

FIG. 2A shows a flow chart of a first part of a method for automating multimodal computational workflows according to a second embodiment of the present disclosure.

FIG. 2B shows a flow chart of a second part of the method for automating multimodal computational workflows of FIG. 2A.

FIG. 3 shows a schematic view of a workflow task lifecycle of a method for automating multimodal computational workflows according to a third embodiment of the present disclosure.

FIG. 4 shows a schematic view of an example of an instruction set.

FIG. 5 shows a schematic view of a system for automating multimodal computational workflows according to a fourth embodiment of the present disclosure.

FIG. 6 shows a flow chart of a method for automating multimodal computational workflows according to a fifth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

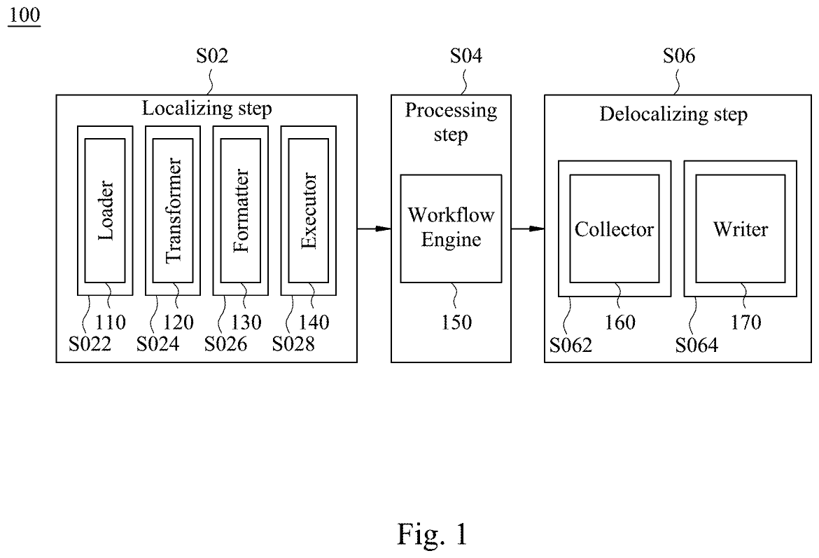

Reference is made to FIG. 1. FIG. 1 shows a flow chart of a method 100 for automating multimodal computational workflows according to a first embodiment of the present disclosure. The method 100 for automating multimodal computational workflows enables an analysis process of an instruction set to be performed automatically in a cloud environment, and includes performing a localizing step S02, a processing step S04 and a delocalizing step S06. The method 100 is corresponding to one task of the instruction set.

The localizing step S02 includes performing a plurality of steps S022, S024, S026, S028. The step S022 includes configuring a loader 110 to load a dataset into dataframes of a memory or copy the dataset to a local host file system from a data source. The step S024 includes configuring a transformer 120 to transform the dataframes of the memory into a transformed dataset so as to optimize downstream data processing. The step S026 includes configuring a formatter 130 to format the transformed dataset to a formatted dataset. The step S028 includes configuring an executor 140 to preprocess the formatted dataset as a managed table for a first command or save the formatted dataset to the local host file system for a second command. The first command is different from the second command.

The processing step S04 includes configuring a workflow engine 150 executing on multiple processors to perform a task command of the instruction set on the dataset copied by the loader, the managed table or the formatted dataset to generate command outputs according to one of the first command and the second command.

The delocalizing step S06 includes performing a plurality of steps S062, S064. The step S062 includes configuring a collector 160 to postprocess the command outputs outputted from the memory or retrieve the command outputs from the local host file system. The step S064 includes configuring a writer 170 to save the command outputs to a storage.

The method 100 configures six operators (i.e., the loader 110, the transformer 120, the formatter 130, the executor 140, the collector 160 and the writer 170) in the operator pipeline to enable the analysis process of Workflow Description Language (WDL) to be performed automatically in a cloud-native environment. Multiple operators are connected in sequence to form the operator pipeline. The input file or the output file of each task can be configured with an operator pipeline to perform workflows with in-memory computing optimization. Therefore, the method 100 of the present disclosure can realize the automation and optimization of processing biomedical data by unifying WDL, Common Workflow Language (CWL), YAML Ain′t Markup Language (YAML), Extensible Markup Language (XML), Structural Query Language (SQL) and Machine Learning (ML) workflows with in-memory computing optimization. Moreover, the present disclosure can support other analysis tools for multimodal, such as Python, R, etc. In other words, the data parallelism combined with the Graphics Processing Unit (GPU) accelerators may be performed via a plurality of steps of an operator pipeline.

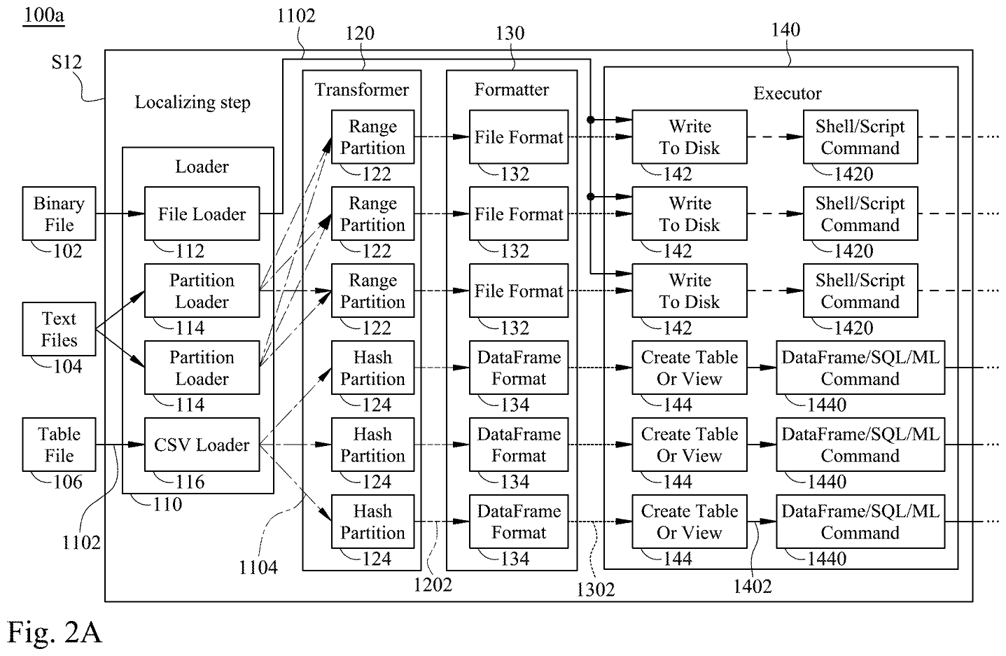

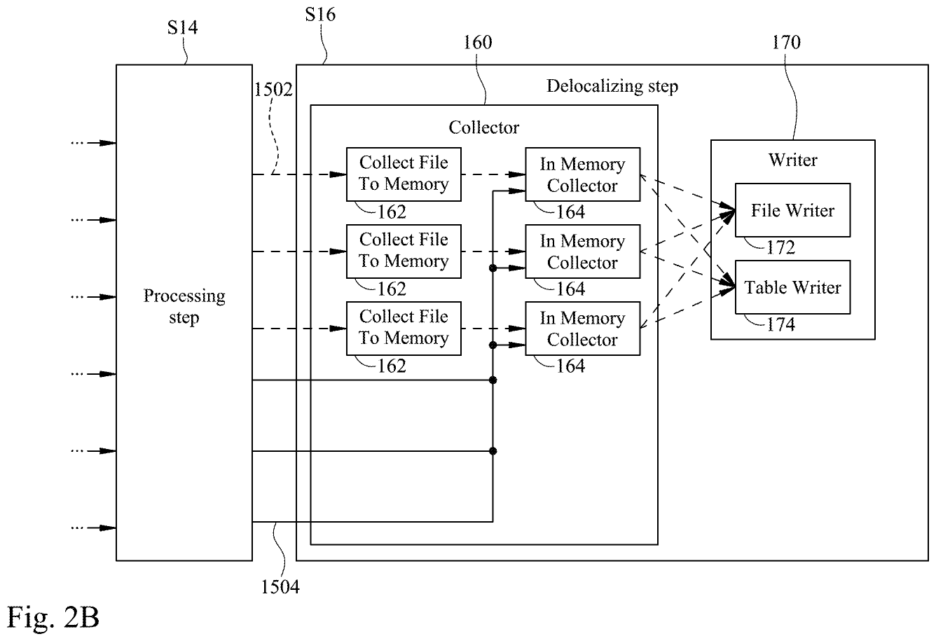

Reference is made to FIGS. 1, 2A and 2B. FIG. 2A shows a flow chart of a first part of a method 100a for automating multimodal computational workflows according to a second embodiment of the present disclosure. FIG. 2B shows a flow chart of a second part of the method 100a for automating multimodal computational workflows of FIG. 2A. The method 100a enables an analysis process of an instruction set to be performed automatically in a cloud environment. The instruction set can be WDL, NextFlow or Common Workflow Language (CWL) and include a plurality of tasks, but the present disclosure is not limited thereto. The method 100a includes performing a localizing step S12, a processing step S14 and a delocalizing step S16. The method 100a is corresponding to one of the tasks of the instruction set.

In the localizing step S12, a loader 110 is configured to load a dataset 1102 into dataframes 1104 of a memory or copy the dataset 1102 to a local host file system from a data source. In detail, the loader 110 is configured to perform single-file read or split one file into multiple files for parallel reading. The loader 110 may include a file loader 112, two partition loaders 114 and a Comma Separated Values (CSV) loader 116. The file loader 112 is configured to copy the dataset 1102 to the local host file system from the data source, thereby performing single-file read. The two partition loaders 114 and the CSV loader 116 are configured to load the dataset 1102 into the dataframes 1104 of the memory, thereby splitting one file into multiple files for parallel reading. The dataset 1102 includes at least one file. In response to determining that the number of the at least one file of the dataset 1102 is plural, the dataset 1102 is regarded as an array of the files and corresponding to a plurality of operator pipelines. In one embodiment, the files may include a binary file 102 inputted into the file loader 112, a plurality of text files 104 inputted into the two partition loaders 114 and a table file 106 inputted into the CSV loader 116, but the present disclosure is not limited thereto.

In the localizing step S12, a transformer 120 is configured to transform the dataframes 1104 of the memory into a transformed dataset 1202 so as to optimize downstream data processing. In detail, the transformer 120 is configured to repartition the dataframes 1104 of the memory based on non-overlapping target regions in genome sequencing analysis. “Transform” of the transformer 120 may be repartitioning, additionally sorting, computing or other action. The transformer 120 may include a plurality of range partitions 122 and a plurality of hash partitions 124. The range partitions 122 receive the dataframes 1104 from the two partition loaders 114. The hash partitions 124 receive the dataframes 1104 from the CSV loader 116. In one embodiment, the transformer 120 can repartition Binary Alignment Map (BAM) datasets or Variant Call Format (VCF) datasets based on non-overlapping target regions in genome sequencing analysis, but the present disclosure is not limited thereto.

In the localizing step S12, a formatter 130 is configured to format the transformed dataset 1202 to a formatted dataset 1302. In detail, the formatter 130 is configured to format the transformed dataset 1202 to the formatted dataset 1302 by converting schema, adding or deleting columns, and encoding domain specific object. The formatter 130 may include a plurality of file formats 132 and a plurality of dataframe formats 134. The file formats 132 receive the transformed datasets 1202 from the range partitions 122. The dataframe formats 134 receive the transformed datasets 1202 from the hash partitions 124.

In the localizing step S12, an executor 140 is configured to preprocess the formatted dataset 1302 as a managed table 1402 for a first command or save the formatted dataset 1302 to the local host file system for a second command. In detail, the first command of the executor 140 is a Structural Query Language (SQL) command (one of DataFrame/SQL/ML Command 1440, ML represent Machine Learning). The second command of the executor 140 is an executable program (Shell/Script command 1420). The executor 140 may include a plurality of write to disk operations 142 (represented by “Write To Disk”) and a plurality of create table or view operations 144 (represented by “Create Table Or View”). The write to disk operations 142 receive the formatted datasets 1302 from the file formats 132 and the dataset 1102 from the file loader 112, thereby saving the formatted datasets 1302 to the local host file system for the second command (Shell/Script command 1420). The create table or view operations 144 receive the formatted datasets 1302 from the dataframe formats 134, thereby preprocessing the formatted datasets 1302 as the managed tables 1402 for the first command (DataFrame/SQL/ML Command 1440).

In the processing step S14, a workflow engine 150 is configured to execute on multiple processors to perform a task command of the instruction set on the dataset 1102 copied by the loader 110, the managed table 1402 or the formatted dataset 1302 to generate command outputs according to one of the first command and the second command. The command outputs include processed command outputs 1502 and processed dataframes 1504.

In the delocalizing step S16, a collector 160 is configured to postprocess the processed dataframes 1504 outputted from the memory or retrieve the processed command outputs 1502 from the local host file system. In detail, in response to determining that the collector 160 retrieves the processed command outputs 1502 from the local host file system, the collector 160 is configured to compute aggregates of the processed command outputs 1502. The processed command outputs 1502 are corresponding to the second command (Shell/Script command 1420). The collector 160 may include a plurality of collect file to memory operations 162 (represented by “Collect File To Memory”) and a plurality of in memory collectors 164. The collect file to memory operations 162 receive the processed command outputs 1502 after performing the processing step S14, thereby retrieving the processed command outputs 1502 from the local host file system. The in memory collectors 164 receive the processed dataframes 1504 after performing the processing step S14, thereby postprocessing the processed dataframes 1504 outputted from the memory.

In the delocalizing step S16, a writer 170 is configured to save the command outputs to a storage. In detail, the writer 170 may include a file writer 172 and a table writer 174. The file writer 172 and the table writer 174 receive outputs from the in memory collectors 164, thereby saving the command outputs to the storage. The storage may be a cloud file system, HyperText Transfer Protocol Secure (HTTPS) repository or Java Database Connectivity (JDBC) database, but the present disclosure is not limited thereto.

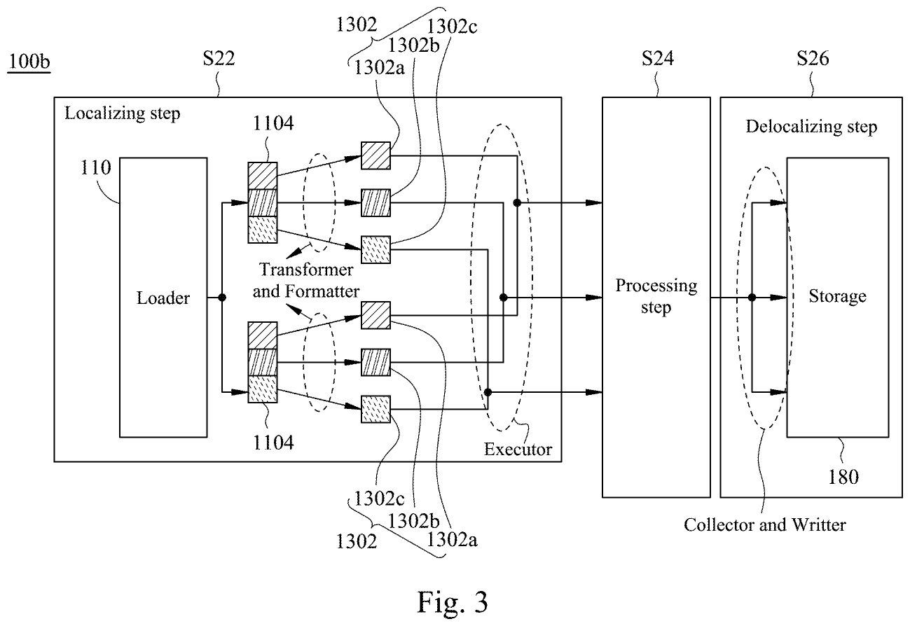

Reference is made to FIGS. 1, 2A, 2B and 3. FIG. 3 shows a schematic view of a workflow task lifecycle of a method 100b for automating multimodal computational workflows according to a third embodiment of the present disclosure. The method 100b includes performing a localizing step S22, a processing step S24 and a delocalizing step S26. The method 100b is corresponding to one task of the instruction set.

In the localizing step S22, a loader 110 is configured to load a dataset 1102 into dataframes 1104 of a memory. A transformer 120 is configured to transform the dataframes 1104 of the memory into a transformed dataset 1202. A formatter 130 is configured to format the transformed dataset 1202 to a formatted dataset 1302. An executor 140 is configured to save a plurality of the formatted datasets 1302 to a local host file system for a second command (Shell/Script command 1420). Each of the formatted datasets 1302 includes a plurality of subparts 1302a, 1302b, 1302c. Same subparts (e.g., two subparts 1302a) of the formatted datasets 1302 are paired together, and the same subparts are corresponding to the formatted datasets 1302, respectively.

In the processing step S24, a workflow engine 150 is configured to execute on multiple processors to perform a task command of the instruction set on the formatted dataset 1302 to generate processed command outputs 1502 according to the second command.

In the delocalizing step S26, a collector 160 is configured to retrieve the processed command outputs 1502 from the local host file system. A writer 170 is configured to save the processed command outputs 1502 to a storage.

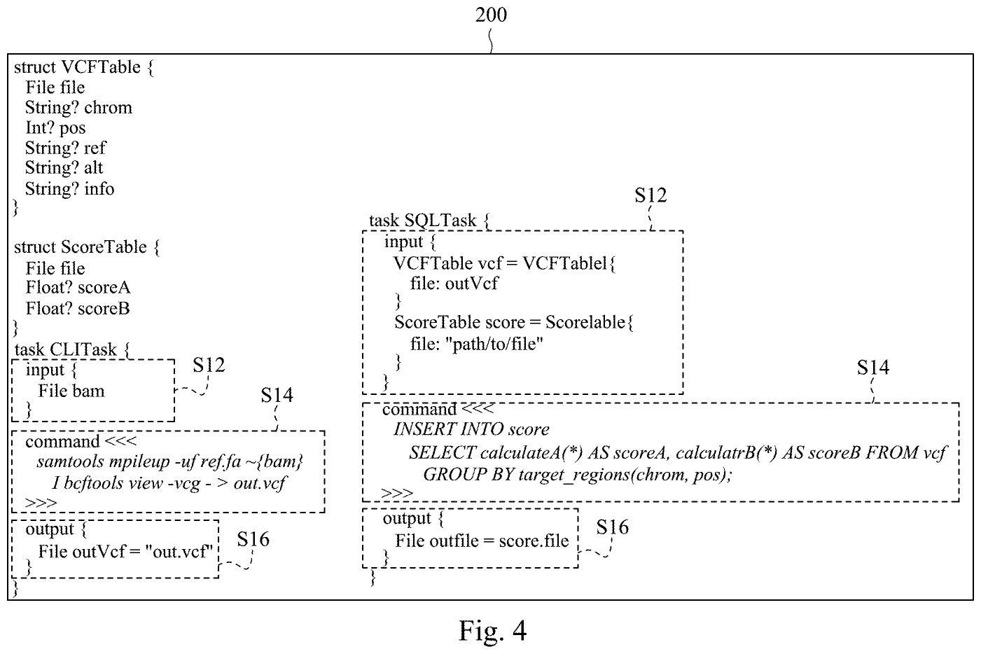

Reference is made to FIGS. 2A, 2B and 4. FIG. 4 shows a schematic view of an example of an instruction set 200 (WDL). The instruction set 200 includes a plurality of tasks CLITask, SQLTask. Each of the tasks CLITask, SQLTask is corresponding to the localizing step S12, the processing step S14 and the delocalizing step S16. Each of inputs (e.g., the binary file 102, the text files 104 and the table file 106) of each of the tasks CLITask, SQLTask is partitioned into a plurality of parts. Same parts of the inputs are performed by a task process, and each of the same parts is corresponding to one of the parts of each of the inputs.

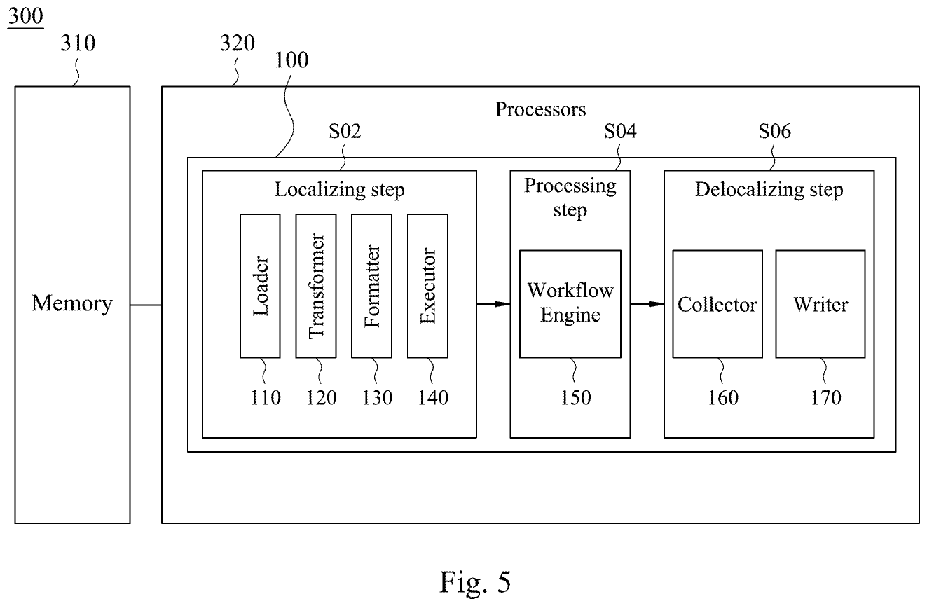

Reference is made to FIGS. 1 and 5. FIG. 5 shows a schematic view of a system 300 for automating multimodal computational workflows according to a fourth embodiment of the present disclosure. The system 300 enables an analysis process of an instruction set to be performed automatically in a cloud environment, and includes a memory 310 and a plurality processors 320. The processors 320 are signally connected to the memory 310. The memory 310 and the processors 320 are configured to perform a method 100 for automating multimodal computational workflows of FIG. 1. The memory 310 may include a random access memory (RAM) or another type of dynamic storage device that may store information and instructions for execution by the processors 320. One of the processors 320 may include any type of processor, microprocessor, cloud processor or GPU. The one of the processors 320 may include a single device (e.g., a single core) and/or a group of devices (e.g., multi-cores).

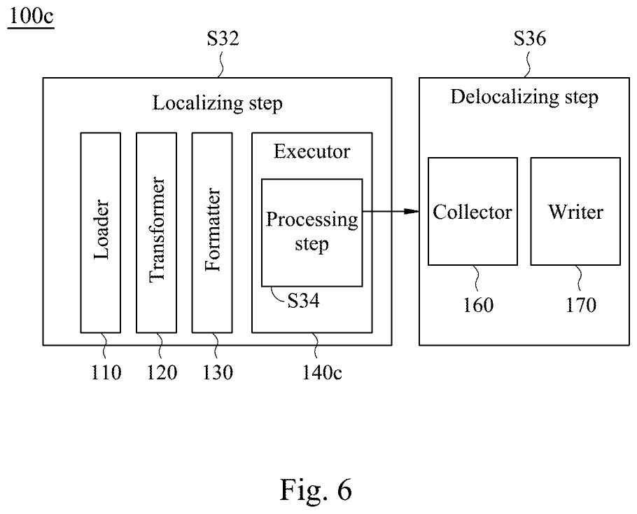

Reference is made to FIGS. 1 and 6. FIG. 6 shows a flow chart of a method 100c for automating multimodal computational workflows according to a fifth embodiment of the present disclosure. The method 100c includes performing a localizing step S32 and a delocalizing step S36. In the localizing step S32, a loader 110, a transformer 120 and a formatter 130 are the same as the loader 110, the transformer 120 and the formatter 130 of FIG. 1. An executor 140c may be configured to perform a processing step S34. In other words, the processing step S34 includes configuring the executor 140c executing on multiple processors to perform a task command of the instruction set on the dataset copied by the loader, the managed table or the formatted dataset to generate command outputs according to one of the first command and the second command. In the delocalizing step S36, a collector 160 and a writer 170 are the same as the collector 160 and the writer 170 of FIG. 1, and will not be described again herein.

Therefore, the methods 100a, 100b, 100c of the present disclosure can realize the automation and optimization of processing biomedical data by unifying WDL, Common Workflow Language (CWL), YAML, XML, Structural Query Language (SQL) and Machine Learning (ML) workflows with in-memory computing optimization. Moreover, the present disclosure can support other analysis tools for multimodal, such as Python, R, etc. In other words, the data parallelism combined with the GPU accelerators may be performed via a plurality of steps of an operator pipeline.

In other embodiment, each of the operator pipelines includes at least one of the loader, the transformer, the formatter and the executor and at least one of the collector and the writer. The system and the method for automating multimodal computational workflows of the present disclosure can determine configuration of the operators according to the requirements.

In other embodiment, the system for automating multimodal computational workflows of the present disclosure includes a memory, a plurality processors and a cache. The processors are signally connected to the memory and the cache. The memory, the processors and the cache are configured to perform the method 100 for automating multimodal computational workflows of FIG. 1. In response to determining that the instruction set is performed automatically in the cloud environment, the cache is configured to record a state of a task, and the workflow engine confirms whether the task is executed completely through a test run (dry run). In response to determining that the task is executed completely through the test run, the task is not re-executed. In response to determining that the task is not executed completely through the test run, the cache records a failure result, and the task is re-executed actually according to the failure result.

It is understood that one of the methods 100, 100a, 100b, 100c for automating multimodal computational workflows of the present disclosure is performed by the aforementioned steps. A computer program of the present disclosure stored on a non-transitory tangible computer readable recording medium is used to perform the method described above. The aforementioned embodiments can be provided as a computer program product, which may include a machine-readable medium on which instructions are stored for programming a computer (or other electronic devices) to perform a process based on the embodiments of the present disclosure. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like). In addition, the present disclosure provides a non-transitory storage medium having instructions therein, when executed, causing multiple processors to perform a method (each of the methods 100, 100a, 100b, 100c) for automating multimodal computational workflows, as exemplified in one of the embodiments. In an embodiment, a storage medium, such as non-transitory storage medium, stores computer-readable instructions (or program code), and the instructions are executed on at least one computing device, such that the at least one computing device carries out a method according to at least one of the embodiments.

According to the aforementioned embodiments and examples, the advantages of the present disclosure are described as follows.
1. The present disclosure can realize the automation and optimization of processing biomedical data by unifying WDL, CWL, YAML, XML, SQL and ML workflows with in-memory computing optimization.
2. The present disclosure can support other analysis tools for multimodal, such as Python, R, etc. In other words, the data parallelism combined with the GPU accelerators may be performed via a plurality of steps of an operator pipeline.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for automating multimodal computational workflows, which enables an analysis process of an instruction set to be performed automatically in a cloud environment, and the method for automating multimodal computational workflows comprising:
performing a localizing step, wherein the localizing step comprises:
configuring a loader to load a dataset into dataframes of a memory or copy the dataset to a local host file system from a data source;
configuring a transformer to transform the dataframes of the memory into a transformed dataset so as to optimize downstream data processing;
configuring a formatter to format the transformed dataset to a formatted dataset; and
configuring an executor to preprocess the formatted dataset as a managed table for a first command or save the formatted dataset to the local host file system for a second command;
performing a processing step, wherein the processing step comprises configuring a workflow engine executing on multiple processors to perform a task command of the instruction set on the dataset copied by the loader, the managed table or the formatted dataset to generate command outputs according to one of the first command and the second command; and
performing a delocalizing step, wherein the delocalizing step comprises:
configuring a collector to postprocess the command outputs outputted from the memory or retrieve the command outputs from the local host file system; and
configuring a writer to save the command outputs to a storage;
wherein the first command is different from the second command.

2. The method for automating multimodal computational workflows of claim 1, wherein in the localizing step, the loader is configured to perform single-file read or split one file into multiple files for parallel reading.

3. The method for automating multimodal computational workflows of claim 1, wherein in the localizing step, the transformer is configured to repartition the dataframes of the memory based on non-overlapping target regions in genome sequencing analysis.

4. The method for automating multimodal computational workflows of claim 1, wherein in the localizing step, the formatter is configured to format the transformed dataset to the formatted dataset by converting schema, adding or deleting columns, and encoding domain specific object.

5. The method for automating multimodal computational workflows of claim 1, wherein in the localizing step, the executor is configured to save a plurality of the formatted datasets to the local host file system for the second command, each of the formatted datasets comprises a plurality of subparts, same subparts of the formatted datasets are paired together, and the same subparts are corresponding to the formatted datasets, respectively;
wherein the first command of the executor is a Structural Query Language (SQL) command, and the second command of the executor is an executable program.

6. The method for automating multimodal computational workflows of claim 1, wherein in the delocalizing step, in response to determining that the collector retrieves the command outputs from the local host file system, the collector is configured to compute aggregates of the command outputs.

7. The method for automating multimodal computational workflows of claim 1, wherein the instruction set comprises a plurality of tasks, each of the tasks is corresponding to the localizing step, the processing step and the delocalizing step, each of inputs of each of the tasks is partitioned into a plurality of parts, same parts of the inputs are performed by a task process, and each of the same parts is corresponding to one of the parts of each of the inputs.

8. The method for automating multimodal computational workflows of claim 1, wherein the dataset comprises at least one file, in response to determining that a number of the at least one file is plural, the dataset is regarded as an array of the files and corresponding to a plurality of operator pipelines;
wherein each of the operator pipelines comprises at least one of the loader, the transformer, the formatter and the executor and at least one of the collector and the writer.

9. The method for automating multimodal computational workflows of claim 1, wherein,
in response to determining that the instruction set is performed automatically in the cloud environment, a cache is configured to record a state of a task, and the workflow engine confirms whether the task is executed completely through a test run;
in response to determining that the task is executed completely through the test run, the task is not re-executed; and
in response to determining that the task is not executed completely through the test run, the cache records a failure result, and the task is re-executed actually according to the failure result.

10. A system for automating multimodal computational workflows, which enables an analysis process of an instruction set to be performed automatically in a cloud environment, and the system for automating multimodal computational workflows comprising:
a memory; and
a plurality processors signally connected to the memory, wherein the memory and the processors are configured to perform a method for automating multimodal computational workflows, and the method for automating multimodal computational workflows comprises:
performing a localizing step, wherein the localizing step comprises:
configuring a loader to load a dataset into dataframes of the memory or copy the dataset to a local host file system from a data source;
configuring a transformer to transform the dataframes of the memory into a transformed dataset so as to optimize downstream data processing;
configuring a formatter to format the transformed dataset to a formatted dataset; and
configuring an executor to preprocess the formatted dataset as a managed table for a first command or save the formatted dataset to the local host file system for a second command;
performing a processing step, wherein the processing step comprises configuring a workflow engine executing on the processors to perform a task command of the instruction set on the dataset copied by the loader, the managed table or the formatted dataset to generate command outputs according to one of the first command and the second command; and
performing a delocalizing step, wherein the delocalizing step comprises:
configuring a collector to postprocess the command outputs outputted from the memory or retrieve the command outputs from the local host file system; and
configuring a writer to save the command outputs to a storage;
wherein the first command is different from the second command.

11. The system for automating multimodal computational workflows of claim 10, wherein the loader is configured to perform single-file read or split one file into multiple files for parallel reading.

12. The system for automating multimodal computational workflows of claim 10, wherein the transformer is configured to repartition the dataframes of the memory based on non-overlapping target regions in genome sequencing analysis.

13. The system for automating multimodal computational workflows of claim 10, wherein the formatter is configured to format the transformed dataset to the formatted dataset by converting schema, adding or deleting columns, and encoding domain specific object.

14. The system for automating multimodal computational workflows of claim 10, wherein the executor is configured to save a plurality of the formatted datasets to the local host file system for the second command, each of the formatted datasets comprises a plurality of subparts, same subparts of the formatted datasets are paired together, and the same subparts are corresponding to the formatted datasets, respectively, the first command is a Structural Query Language (SQL) command, and the second command is an executable program.

15. The system for automating multimodal computational workflows of claim 10, wherein in response to determining that the collector retrieves the command outputs from the local host file system, the collector is configured to compute aggregates of the command outputs.

16. The system for automating multimodal computational workflows of claim 10, wherein the instruction set comprises a plurality of tasks, each of the tasks is corresponding to the localizing step, the processing step and the delocalizing step, each of inputs of each of the tasks is partitioned into a plurality of parts, same parts of the inputs are performed by a task process, and each of the same parts is corresponding to one of the parts of each of the inputs.

17. The system for automating multimodal computational workflows of claim 10, wherein the dataset comprises at least one file, in response to determining that a number of the at least one file is plural, the dataset is regarded as an array of the files and corresponding to a plurality of operator pipelines;
wherein each of the operator pipelines comprises at least one of the loader, the transformer, the formatter and the executor and at least one of the collector and the writer.

18. The system for automating multimodal computational workflows of claim 10, further comprising:
a cache signally connected to the processors, wherein the memory, the processors and the cache are configured to perform the method for automating multimodal computational workflows;
wherein in response to determining that the instruction set is performed automatically in the cloud environment, the cache is configured to record a state of a task, and the workflow engine confirms whether the task is executed completely through a test run;
in response to determining that the task is executed completely through the test run, the task is not re-executed; and
in response to determining that the task is not executed completely through the test run, the cache records a failure result, and the task is re-executed actually according to the failure result.

19. A non-transitory storage medium having instructions therein, when executed, causing multiple processors to perform a method for automating multimodal computational workflows, and the method for automating multimodal computational workflows comprising:
performing a localizing step, wherein the localizing step comprises:
configuring a loader to load a dataset into dataframes of a memory or copy the dataset to a local host file system from a data source;
configuring a transformer to transform the dataframes of the memory into a transformed dataset so as to optimize downstream data processing;
configuring a formatter to format the transformed dataset to a formatted dataset; and
configuring an executor to preprocess the formatted dataset as a managed table for a first command or save the formatted dataset to the local host file system for a second command;
performing a processing step, wherein the processing step comprises configuring a workflow engine executing on the multiple processors to perform a task command of the instruction set on the dataset copied by the loader, the managed table or the formatted dataset to generate command outputs according to one of the first command and the second command; and
performing a delocalizing step, wherein the delocalizing step comprises:
configuring a collector to postprocess the command outputs outputted from the memory or retrieve the command outputs from the local host file system; and
configuring a writer to save the command outputs to a storage;
wherein the first command is different from the second command.

20. The non-transitory storage medium of claim 19, wherein,
in the localizing step, the loader is configured to perform single-file read or split one file into multiple files for parallel reading, the transformer is configured to repartition the dataframes of the memory based on non-overlapping target regions in genome sequencing analysis, the formatter is configured to format the transformed dataset to the formatted dataset by converting schema, adding or deleting columns, and encoding domain specific object, the executor is configured to save a plurality of the formatted datasets to the local host file system for the second command, each of the formatted datasets comprises a plurality of subparts, same subparts of the formatted datasets are paired together, the same subparts are corresponding to the formatted datasets, respectively, the first command of the executor is a Structural Query Language (SQL) command, and the second command of the executor is an executable program; and
in the delocalizing step, in response to determining that the collector retrieves the command outputs from the local host file system, the collector is configured to compute aggregates of the command outputs.
